(19) United States
(12) Patent Application Publication
(10) Pub. No.: US 2008/0278408 A1
(43) Pub. Date: Nov. 13, 2008

(54) FLOOR DISPLAY SYSTEMS AND ADDITIONAL DISPLAY SYSTEMS, AND METHODS AND COMPUTER PROGRAM PRODUCTS FOR USING FLOOR DISPLAY SYSTEMS AND ADDITIONAL DISPLAY SYSTEM

(75) Inventors: David R. Strickland, Blue Ridge, VA (US); Ronald D. Blum, Roanoke, VA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: IntelliMat, Inc.

(21) Appl. No.: 11/928,264

(22) Filed: Oct. 30, 2007

Related U.S. Application Data
(63) Continuation-in-part of application No. 11/769,418, filed on Jun. 27, 2007.
Application No. 11/769,418 is a continuation-in-part of application No. 11/735,908, filed on Apr. 16, 2007.
Application No. 11/735,908 is a continuation-in-part of application No. 11/316,928, filed on Dec. 27, 2005.
Application No. 11/316,928 is a continuation of application No. 10/454,631, filed on Jun. 5, 2003, now Pat. No. 7,009,523.
Application No. 10/454,631 is a continuation-in-part of application No. 10/438,923, filed on May 16, 2003, now Pat. No. 6,982,649.
Application No. 10/438,923 is a continuation-in-part of application No. 10/285,639, filed on Nov. 1, 2002, now Pat. No. 6,873,266.
Application No. 10/285,639 is a continuation of application No. 10/137,357, filed on May 3, 2002, now Pat. No. 6,507,285.
Application No. 10/137,357 is a continuation of application No. 09/767,846, filed on Jan. 24, 2001, now Pat. No. 6,417,778.
Application No. 09/767,846 is a continuation of application No. 09/418,752, filed on Oct. 15, 1999, now abandoned.
Application No. 09/418,752 is a continuation-in-part of application No. 09/304,051, filed on May 4, 1999, now Pat. No. 6,219,876.
Application No. 11/735,908 is a continuation-in-part of application No. 10/804,090, filed on Mar. 19, 2004, now abandoned.
Application No. 10/804,090 is a continuation-in-part of application No. 10/682,435, filed on Oct. 10, 2003, now Pat. No. 6,917,301.
Application No. 10/682,435 is a continuation-in-part of application No. 10/438,923, filed on May 16, 2003, now Pat. No. 6,982,649.
Application No. 11/735,908 is a continuation-in-part of application No. 10/759,167, filed on Jan. 20, 2004, now Pat. No. 7,205,903.
Application No. 10/759,167 is a continuation-in-part of application No. 10/682,435, filed on Oct. 10, 2003, now Pat. No. 6,917,301.
Application No. 11/735,908 is a continuation-in-part of application No. 11/199,130, filed on Aug. 9, 2005, now Pat. No. 7,358,861.
Application No. 11/199,130 is a continuation-in-part of application No. 11/002,276, filed on Dec. 3, 2004, now Pat. No. 7,145,469.
Application No. 11/002,276 is a continuation-in-part of application No. 10/454,631, filed on Jun. 5, 2003, now Pat. No. 7,009,523.
(60) Provisional application No. 60/385,579, filed on Jun. 5, 2002.
(60) Provisional application No. 60/378,070, filed on May 16, 2002.
(60) Provisional application No. 60/457,115, filed on Mar. 21, 2003.
(60) Provisional application No. 60/460,353, filed on Apr. 3, 2003.
(60) Provisional application No. 60/418,626, filed on Oct. 12, 2002.
(60) Provisional application No. 60/428,387, filed on Nov. 21, 2002.
(60) Provisional application No. 60/429,044, filed on Nov. 23, 2002.
(60) Provisional application No. 60/441,408, filed on Jan. 22, 2003.
(60) Provisional application No. 60/599,878, filed on Aug. 10, 2004.
(60) Provisional application No. 60/526,271, filed on Dec. 3, 2003.

(51) Int. Cl. G09G 5/00

(52) U.S. Cl. 345/1.1

(57) ABSTRACT

Improved display systems, methods, and computer program products for advertising and other content delivery using one or more floor display systems are provided. A floor display system and an elevated horizontal display system, which may be configured on a countertop, may be used and able to communicate with one another. The display systems may be able to send and receive signals between each other and with a network server or configuring device to operate in cooperation with one another and as instructed. Display systems may be configured to interface with customers to obtain information and configured to detect information about customers proximate the display systems and to use the information to provide improved content delivery to the customer.

### CROSS-REFERENCE TO RELATED APPLICATIONS

This application claims the benefit of the earlier filing date of and is a continuation-in-part of commonly owned co-pending application Ser. No. 11/769,418, filed Jun. 27, 2007, which is a continuation of application Ser. No. 11/735,908, filed Apr. 16, 2007, which is a continuation-in-part of application Ser. No. 11/316,928, filed Dec. 27, 2005, which is a continuation of application Ser. No. 10/454,631, filed Jun. 5, 2003, and issued as U.S. Pat. No. 7,009,523 on Mar. 7, 2006, which claims the benefit under 35 U.S.C. 119(e) of Provisional Application Ser. No. 60/385,579, filed Jun. 5, 2002, and which is a continuation-in-part of co-pending application Ser. No. 10/438,923, filed May 16, 2003, and issued as U.S. Pat. No. 6,982,649 on Jan. 3, 2006, which claims the benefit under 35 U.S.C. 119(e) of Provisional Application Ser. No. 60/378,070, filed May 16, 2002, and which is a continuation-in-part of co-pending application Ser. No. 10/285,639, filed Nov. 1, 2002, and issued as U.S. Pat. No. 6,873,266 on Mar. 29, 2005, which is a continuation of application Ser. No. 10/137,357, filed May 3, 2002, and issued as U.S. Pat. No. 6,507,285 on Jan. 14, 2003, which is a continuation of application Ser. No. 09/767,846, filed Jan. 24, 2001, and issued as U.S. Pat. No. 6,417,778 on Jul. 9, 2002, which is a continuation of application Ser. No. 09/418,752, filed Oct. 15, 1999, and now abandoned, which is a continuation-in-part of application Ser. No. 09/304,051, filed May 4, 1999, and issued as U.S. Pat. No. 6,219,876 on Apr. 24, 2001. Application Ser. No. 11/735,908 is also a continuation-in-part of application Ser. No. 10/804,090, filed Mar. 19, 2004, which claims the benefit under 35 USC 119(e) of Provisional Application Ser. No. 60/457,115, filed Mar. 21, 2003, and Provisional Application Ser. No. 60/460,353 filed Apr. 3, 2003, and which is a continuation-in-part of application Ser. No. 10/682,435, filed Oct. 10, 2003, and issued as U.S. Pat. No. 6,917,301 on Jul. 12, 2005, which claims the benefit under 35 U.S.C. 119(e) of Provisional Applications identified as follows: Ser. No. 60/418,626, filed Oct. 12, 2002; Ser. No. 60/428,387, filed Nov. 21, 2002; and Ser. No. 60/429,044, filed Nov. 22, 2003, and which is a continuation-in-part of application Ser. No. 10/438,923, previously identified. Application Ser. No. 11/735,908 is also a continuation-in-part of application Ser. No. 10/759,167, filed Jan. 20, 2004, and issued as U.S. Pat. No. 7,205,903 on Apr. 17, 2007, which claims the benefit under 35 U.S.C. 119(e) of Provisional Application Ser. No. 60/441,408, filed Jan. 22, 2003, and which is a continuation-in-part of co-pending application Ser. No. 10/682,435, previously identified. Application Ser. No. 11/735,908 is also a continuation-in-part of application Ser. No. 11/199,130, filed Aug. 9, 2005, which claims the benefit under 35 U.S.C. 119(e) of Provisional Application Ser. No. 60/599,878, filed Aug. 10, 2004, and which is a continuation-in-part of co-pending application Ser. No. 11/002,276, filed Dec. 3, 2004, and issued as U.S. Pat. No. 7,145,469 on Dec. 5, 2006, which claims the benefit under 35 U.S.C. 119(e) of Provisional Application Ser. No. 60/526,271, filed Dec. 3, 2003, and which is a continuation-in-part of co-pending application Ser. No. 10/454,631, previously identified. Each of the above-identified applications is fully incorporated herein by reference. Also incorporated herein by reference are the following applications: application Ser. No. 11/298,668, filed Dec. 12, 2005, which is a divisional of application Ser. No. 10/413,219, filed Apr. 15, 2003, which claims the benefit under 35 USC 119(e) of Provisional Application Ser. No. 60/448,598, filed Feb. 20, 2003; and application Ser. No. 11/298,668, filed Dec. 12, 2005, which is a divisional of application Ser. No. 10/413,219, filed Apr. 15, 2003, which claims the benefit under 35 USC 119(e) of Provisional Application Ser. No. 60/448,598, filed Feb. 20, 2003.

### BACKGROUND OF THE INVENTION

Advertising and other kinds of messaging are typically presented in forms that use individual “vertical spaces,” including billboards, walls, ceiling-hung displays, and the like. On the other hand, one kind of space that has great potential for advertising and messaging, but has been largely overlooked, is horizontal space, such as floor space.

There have been efforts to exploit floor space for advertising. For example, adhesive (i.e., “stick-on”) floor decals are known. Such decals may include a colorful image and convey some kind of advertising message, such as “Drink Milk.” Such an advertising medium is limited, however, by the fact that the message is static and not easily changed. Some other efforts have been made to exploit floor space for advertising, such as described in U.S. Pat. No. 5,848,830 Castle et al. The '830 Castle patent describes inserting static poster substrates showing graphics into a pocket of a lighted floor device.

However, there remain challenges to effectively and efficiently communicate to an audience by displaying visual advertising or messaging on the floor. Therefore, a need exists and it would be advantageous to have improved floor and other horizontal displays and systems and methods of using the same.

### BRIEF SUMMARY OF THE INVENTION

Embodiments of the invention address the above needs and achieve other advantages by providing apparatus, methods, and computer program products for displaying electronically modifiable verbal and graphical messages and/or other content on horizontal surfaces including a floor and communicating with multiple displays and between display systems. Generally, embodiments of the present invention provide apparatus, methods, and computer program products for displaying electronically modifiable verbal messages and graphical messages on one or more floor surfaces and also one or more other elevated horizontal surfaces. In particular, a floor display system may occupy an area of a floor and may be used in conjunction with a horizontal display system on one or more elevated surfaces. More specifically, improved display architectures, systems, methods, and computer program products of the present invention for advertising and other content delivery using one or more floor display systems are described herein. A floor display system and an elevated horizontal display system, which may be configured on a countertop, may be used and able to communicate with one another. The display systems may be able to send and receive signals between each other and with a network server or configuring device to operate in cooperation with one another and as instructed. Display systems may be configured to interface with customers to obtain information and configured to detect information about customers proximate the display systems and to use the information to provide improved content delivery to the customer.

One embodiment of the present invention includes a floor display system and other display systems for displaying verbal and graphical messages and/or other content. For instance, an embodiment may include a floor display system and a horizontal display system that is elevated above the floor and includes an electronic display screen in a plane substantially parallel to the floor. The horizontal display system that is elevated above the floor may be supported by a countertop; may be positioned, for example, on or in a countertop; may be supported by and separable from a countertop; and/or may be removably secured to a countertop.

A floor display system and another display system such as an elevated horizontal display system may be configured to send and receive signals or otherwise communicate with each other. Another display system may be positioned in a plane substantially parallel to a wall or otherwise substantially perpendicular to a floor and configured to send and receive signals or otherwise communicate with a floor display system and an elevated horizontal display system. At least one display system may include a surround, which may be modular. And the surround may include a tapered transition to a supporting elevated horizontal surface.

Another embodiment of the present invention may include a method of communicating between two or more display systems, where one system is on a floor and includes an electronic display screen in a plane substantially parallel to the floor and configurable to display an electronically modifiable verbal content and an electronically modifiable graphic content. The method may also include receiving a first signal at the first display system. Further, the method may include presenting at least one of an electronically modifiable verbal and an electronically modifiable graphic content on the first display system based at least in part upon the first signal. A method may also include detecting an identity device proximate the first display system, wherein detecting an identity device comprises receiving information from the identity device; receiving a second signal at the first display system indicating the detection of the identity device proximate the first display system and providing the information from the identity device; and/or presenting at least one of an electronically modifiable verbal content and an electronically modifiable graphic content on the first display system based at least in part upon the second signal. A method may also include providing at second display system comprising an electronic display screen in a plane substantially parallel to the floor and configurable to display an electronically modifiable verbal content and an electronically modifiable graphic content; sending a second signal from the first display system to the second display system; receiving the second signal at the second display system; and/or presenting at least one of an electronically modifiable verbal content and an electronically modifiable graphic content on the second display system based at least in part upon the second signal. A method may also include sending a third signal from the second display system to the first display system; receiving the third signal at the first display system; and/or presenting at least one of an electronically modifiable verbal content and an electronically modifiable graphic content on the first display system based at least in part upon the third signal. A method may also include detecting an identity device proximate one of the first and second display systems, wherein detecting an identity device comprises receiving information from the identity device; receiving a third signal at the display system to which the identity device is proximate, the fourth signal indicating the detection of the identity device proximate the display system to which the identity device is proximate and providing the information from the identity device; and/or presenting at least one of an electronically modifiable verbal content and an electronically modifiable graphic content on the display system to which the identity device is proximate based at least in part upon the third signal. A method may also include sending a fourth signal from the display system to which the identity device was proximate to the other display system, wherein the fourth signal comprises at least one of the information from the identity device, an indication of the content presented on the display system to which the identity device was proximate when the identity device was detected proximate the display system, an indication of the content presented on the display system to which the identity device was proximate after the identity device was detected proximate the display system, and the location of the display system to which the identity device was proximate; receiving the fourth signal at the other display system; detecting the identity device proximate the other display system, wherein detecting the identity device comprises receiving information from the identity device; receiving a fifth signal at the other display system, the fifth signal indicating the detection of the identity device proximate the other display system and providing the information from the identity device; and/or presenting at least one of an electronically modifiable verbal content and an electronically modifiable graphic content on the display system to which the identity device is proximate based at least in part upon the fourth and fifth signals.

Yet another embodiment of the present invention may include computer program product comprising a computer-useable medium having control logic stored therein for controlling content presented on a plurality of display systems. A computer program product of an embodiment of the present invention may include control logic to perform one or more of the methods described above. The characteristics describe above, as well as additional details, of the present invention are described below. Similarly, corresponding and additional embodiments of the present invention and related systems, methods, and computer program products therefore are also described below.

Countertop display systems and other display systems that are adapted for “horizontal space” have been overlooked and have a great potential for advertising and messaging particularly in combination with other horizontal displays, including floor displays and elevated horizontal displays. The embodiments of the present invention provide the new tools to display content, such as advertising information, in locations and at times that are strategically geared toward the consumer.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 shows a display system and related interactivity devices which may be associated with and/or interact with the display system according to embodiments of the present invention;

FIG. 2 shows a display system according to embodiments of the present invention;

FIG. 3 shows a display system according to embodiments of the present invention;

FIG. 4 shows a display system according to embodiments of the present invention;

FIGS. 5A and 5B show display systems according to embodiments of the present invention;

FIG. 6 shows the back portion of a display system according to embodiments of the present invention;

FIG. 7 shows a countertop display system according to embodiments of the present invention;

FIGS. 8 and 9 show protective covers according to embodiments of the present invention;

FIGS. 10 and 11 show components and assembly of a display system according to embodiments of the present invention;

FIG. 12 shows a display system including a contact-less mechanism for obtaining identity information from an identity device;

FIG. 13 shows a countertop display system according to embodiments of the present invention;

FIG. 14 shows various display systems according to embodiments of the present invention;

FIG. 15 shows a direct-link arrangement for configuring a display system according to embodiments of the present invention;

FIG. 16 shows a LAN arrangement for configuring display systems according to embodiments of the present invention;

FIG. 17 shows another LAN arrangement for configuring display systems according to embodiments of the present invention;

FIG. 18 shows a WAN/Internet arrangement for configuring display systems according to embodiments of the present invention;

FIG. 19 shows a flowchart of communications between a server and display system and between display systems; and

FIG. 20 shows various arrangements for configuring display systems according to embodiments of the present invention.

### DETAILED DESCRIPTION OF THE INVENTION

The present invention now will be described more fully hereinafter with reference to the accompanying drawings, in which some but not all embodiments of the inventions are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

### I. Introduction and Definitions

A floor display system and one or more additional display systems may be arranged in a public place, such as a commercial establishment or other public building or a private establishment, and be configured to display electronically modifiable content, such as advertising or other informational content.

“Floor” as used herein means floor, ground, or any surfaces thereof including concrete, asphalt, carpeting, wood, linoleum, tile, rubber, vinyl and the like. A floor may include stairs, a stage floor, an elevator floor, an escalator, a moving walkway, or the like surface upon which individuals may stand, walk, dance, etc.

“Electronically modifiable” as used herein means changing images through the use of electronics. It includes presenting a first image on a display and then presenting a second image on the display. However, electronically modifiable does not include such functions as illuminating and de-illuminating static graphics or simply turning lights on and off that are arranged to form an image. An example of electronically modifiable is the dynamic changing of images on a television screen.

“Content” as used herein means text, graphics, sound, and the like. Content includes various types of information in various forms, such as images displayed on a television screen or computer monitor.

A floor display system and additional display systems may have many different arrangements. For example, one or more floor display systems may be used along with one or more elevated display systems. An elevated display system may be a display system configured to be on or in an elevated horizontal surface such as a countertop, tabletop, desktop, or bar top (collectively referred to herein as a “countertop”), or any other elevated horizontal surface. An elevated display system may be a display system configured to be on, in, or in a plane parallel to a vertical surface such as a wall, side of a piece of furniture, or any other vertical surface. In another example, a floor display system may be used with a countertop display system and a vertically-oriented display system.

### II. Structure of Display System

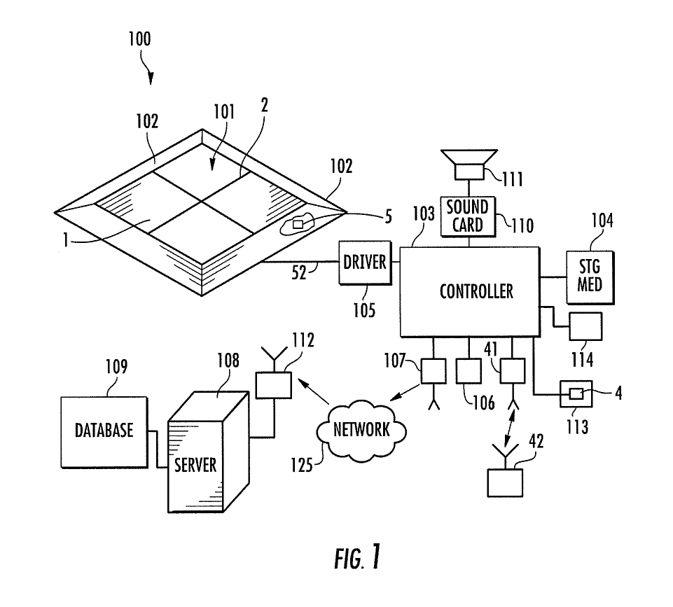

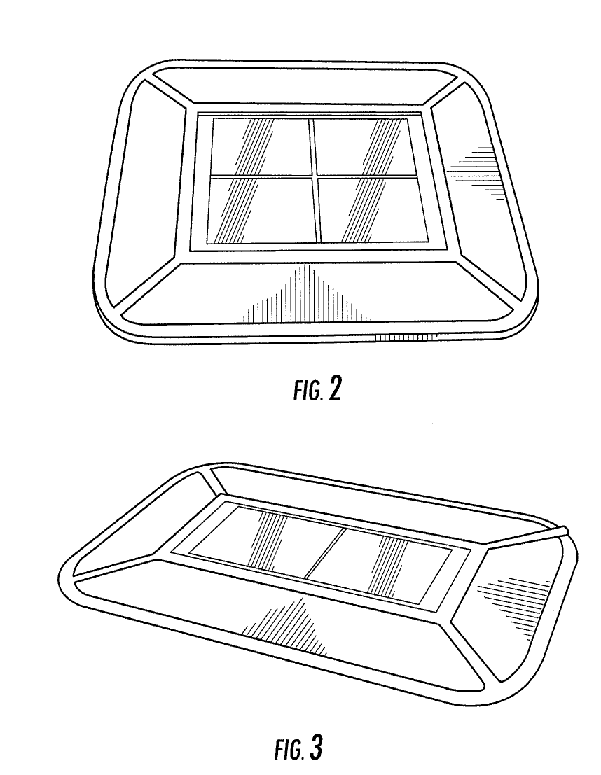

As shown in FIG. 1, a display system 100 may be a rectangular device with a single electronic display screen 101 or two or more composite electronic displays 1 that make up one or more display screens 101. In one embodiment, the electronic display screen 101 may be approximately nineteen inches measured diagonally. The display system 100 may be approximately twenty-four inches long and between nineteen and thirty-four inches wide. In an embodiment where two or more electronic displays 1 make up one or more display screens 101, a display system 100 may include perpendicular cross-beams 2. The cross-beams 2 may be approximately eighteen inches long and three-quarters of an inch wide. Of course, the display system 100, electronic display screens 101, and cross-beams 2 may have other dimensions and geometric arrangements, such as including diagonal cross-beams. The cross-beams 2 may include Corian®, rubber, plastic, metal, wood, urethanes, or the like. The cross-beams 2 and other components of the display system 100 may be held together, for example, with adhesive, epoxy, mechanical fasteners, or the like. The cross-beams 2 may provide added support for the structure so that the display system can withstand increased loads on its front face (top surface), such as from individuals walking or standing on the system, rolling a cart over the system, or the like. In an embodiment where two or more electronic displays 1 make up one or more display screens 101, the electronic displays 1 may be used in a manner that coordinates the visual image(s) presented on the electronic displays 1 to form one display, two displays, three displays, four displays, etc., up to at least the number of electronic displays 1 that are used. For example, two separate electronic display screens 101 may be formed by combining two electronic displays 1 arranged vertically or horizontally. FIGS. 2 and 3 show additional embodiments which may benefit from arrangements of multiple electronic displays making up one or more display screens.

A display system 100 according to embodiments of the present invention may include a display screen 101 associated with a surround 102. More specifically, the display screen 101 may be at least partly connected to, supported by, received within or otherwise associated with the surround 102. A surround 102 and an electronic display screen 101 may be specifically designed to be used in specific places, including where there is foot traffic or other types of traffic on horizontal surfaces, such as products placed upon countertops. The surround 102 may be affixed to a floor or a countertop or may be portable so that it can be easily moved to different places. Accordingly, a surround 102 and a display screen 101 may be sturdy and durable enough that they may be repeatedly stepped on, walked over, or have a wheeled shopping cart or other rolling or sliding object traverse them, with negligible adverse effect on the surround 102 and the display screen 101.

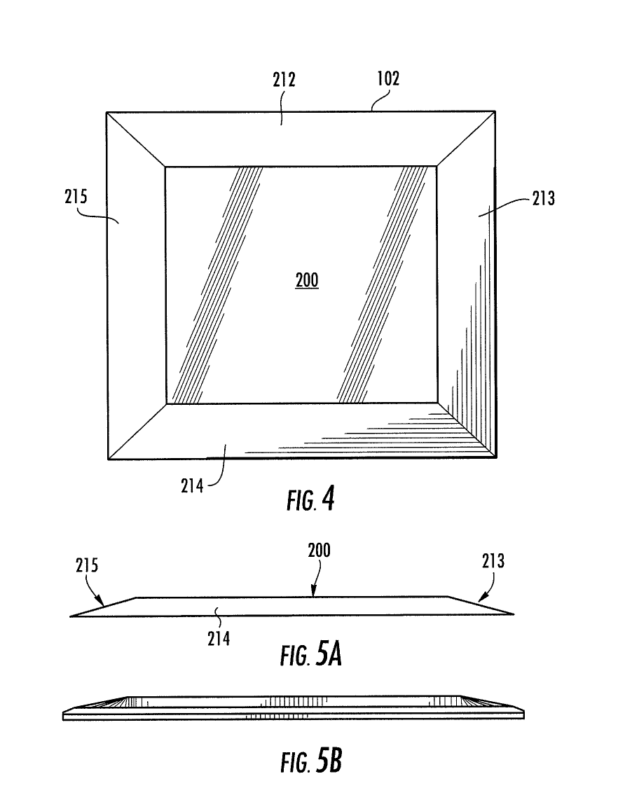

FIGS. 4 and 5A and 5B are a top or plan view and side orthogonal or elevation views, respectively, of a surround 102 of an embodiment for a display system of the present invention. As shown in a surround 102 could comprise at least one inclined surface, such as a tapered or curved (concave, convex, or some non-uniform) surface. More specifically, a surround 102 could comprise a plurality of planar inclined surfaces 212, 213, 214 and 215 that slope downward and away from a top surface 200 (which may be the surface of a protective cover of the display screen 101, as described below) so that the entire perimeter of the surround presents an inclined surface. Such a structure may make the surround easier to cross over, by a person walking over a floor surround or by a wheeled shopping cart, for example, if the floor surround is placed in the aisles of a commercial establishment, or by a person's hand moving over a surround on a countertop for example, of the surround is part of a countertop display system.

A surround 102 of a display system 100 may be rectangular, oval, or various other shapes. A surround 102 of a display system 100 may have a smooth, inclined surface, a rough surface, or various other types of surface textures. A surround 102 of a display system 100 may include Corian®, rubber, plastic, metal, wood, urethanes, or the like. A surround may have a decorative appearance. For example, a surround may be decorated with pictures of balloons and the word “Celebration” pictured near the balloons.

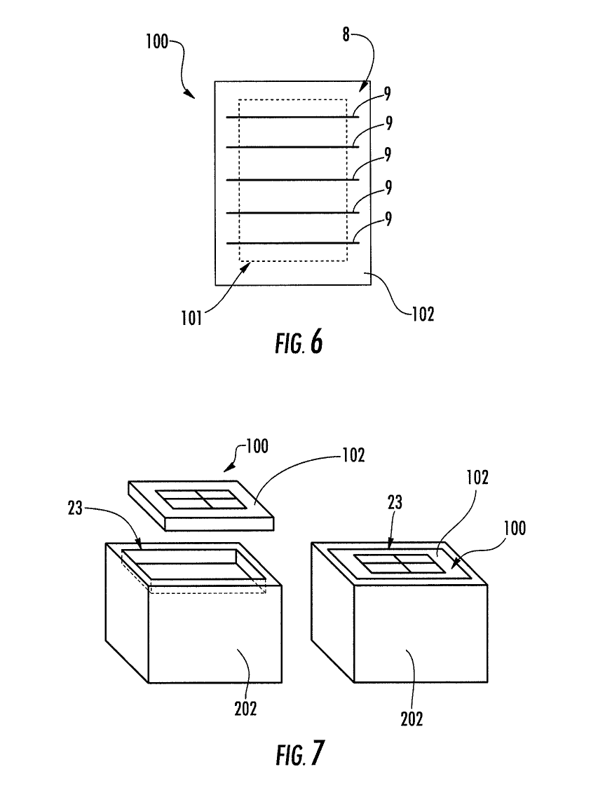

As shown in FIG. 6, the back portion 8 may include ribs 9 providing support for an electronic display screen 101 from its bottom (rear) surface of a display system 100. Ribs 9 may include steel, rubber, plastic, or other materials and may be formed in various manners such as corresponding to the shape of the bottom surface of the electronic display screen 101. Ribs 9 may be welded or attached by another process to the back portion 8 of a display system 100. Ribs 9 may be straight, curved, or having another shape in length, may have any type of cross section, including, for example, circular, square, rectangular, triangular, etc., and may have surfaces of any texture or shape, including, for example, smooth, rough, dimpled, concave, convex, etc.

A display system 100 may also include a modular surround 102 that can be removed and interchanged with other surrounds. For instance, surrounds with different colors, textures, or shapes may be attached to the display system 100 without disassembling the display system 100. Also, a surround may be adjustable such that the surround can be inclined at various angles or the like. Also, as shown in FIG. 7, a display system 100 may have a surround 102 that is specially adapted in shape and structure to correspond with the shape of and fit within a recess 23 for a particular elevated horizontal structure 202 that supports or contains the display system 100. For example, the sides of a recess 23 may be flat and vertically oriented to correspond with flat and vertically oriented edges of the surround 102 of a display system 100. Alternatively, for example, the sides of a recess 23 may be tapered such as at a 45 degree angle decreasing the opening of the recess 23 to correspond with tapered edges of the surround 102 of a display system 100, thereby facilitating a configuration that permits the display system 100 to be placed within the recess 23 where the shape of the recess and surround 102 align the display system 100 within the recess 23. The sides of a recess 23 and edges of a surround 102 need not correspond precisely, but may allow for a space between the surround 102 and recess 23 when the display system 100 is installed in the recess 23, for example, where the sides of a recess 23 are tapered at a 45 degree angle and the edges of a surround 102 are tapered at a 40 degree angle. Surfaces other than tapers may also be used, such as matching concaved and convex curved surfaces, stepped surfaces, or other configurations. A recess may be shaped or “keyed” in such a manner that a corresponding display system 100 can only be placed within the recess 23 in a single orientation. Alternatively, a recess may be shaped in such a manner that a corresponding display system 100 may be placed within the recess 23 in more than one orientation, such as in a forward facing or a rear facing orientation.

U.S. Pat. No. 6,417,778, which is incorporated herein by reference in its entirety, discloses a system for electronically conveying information via a floor display. More specifically, the floor display may incorporate an electronic display comprising, for example, one or more liquid crystal display. The display could be connected to a computer and a computer generated image could be electronically displayed on the display. Thus, the image displayed on the display could be modified by generating a different computer image and displaying that computer image on the display. The electronically modifiable display could utilize a plurality of different graphics that can be displayed in any of a variety of manners on the display. For example, the graphics could be displayed in a generally fixed position on the display or could scroll across the display, with both exemplary methodologies displaying multiple graphics either individually or in combination. Display systems of the present invention, which may be configured on a countertop or the like, may include similar features as a floor display system like that described in the '778 patent.

Display technologies that may be utilized in embodiments of the present invention include liquid crystal displays (LCDs), light-emitting diodes (LEDs), organic light-emitting diodes (OLEDs), electroluminescent (EL) displays, plasma display panels (PDPs), field emission displays (FEDs) including printable field emitters, ferroelectric displays, polymeric light emitting diodes (PLEDs), light emitting polymers (LEPs), electronic paper, and light-emitting ceramic or other light-emitting inorganic materials. Additional display technologies that may be utilized in embodiments include optical fiber technology, such as where a remote image is formed electronically and transmitted utilizing a light guiding source to fiber arrays or bundles. The remote image light source could be internal or external to a surround. All such known or future developed display technologies that are configured to provide electronically modifiable displays may be used.

Alternatives to modifying graphics displayed on the display systems as disclosed above include using light emitting polymers to create, and thus change, the graphics. The light emitting polymers can be applied to, attached to, or woven into a display system 100. The light emitting polymers may be utilized on any portion of the different embodiments for a display system 100. Light emitting polymers are known and described in U.S. Pat. Nos. 5,945,502, 5,869,350, and 5,571,626, which are incorporated herein by reference in their entirety. Other options for a display are to use electronic ink or electric paper.

A display system 100 of the present invention is capable of displaying at least verbal and graphic images. The displayed content may include verbal images alone, graphic images (e.g., pictures) alone, or combinations of the two, either static, moving, or both static and moving, in accordance with selected video content. Moving verbal and graphic images may, for example, be scrolled. The verbal and graphic images could be black and white or in full color. A display system may include more than one distinct electronic display. That is, the display screen of a display system may be electronically and/or physically partitioned with respect to content. For example, the display screen could include two or more different “windows,” each displaying different content. Such a virtual partitioning of a screen is well known, for example, in “split-screen” TV and through the widespread use of various graphics software applications, including the ubiquitous “Windows” software by Microsoft®. Similarly, virtually correlating two or more physically distinct electronic displays to create the perception of a single electronic display is well known.

An electronic display screen may be coupled by a wired or wireless connection 52 to a controller and modifiable via the controller to display any content chosen by a user. For example, as shown in FIG. 1, the electronic display screen 101 may be coupled to the controller 103 via a display driver circuit such as a video graphics adapter card 105. The controller 103 may include any kind of electronic logic circuit, for example, a general microprocessor configurable with software, or an ASIC (application specific integrated circuit). The driver 105 of the display system may be integrated with the controller 103 or built into an ASIC. The controller may also be in the form of a single board computer with a processor and memory and with one or more display driving circuits built onto the board, as well as wireless components for communicating with the outside world or for loading data into memory. The electronic display screen 101 may be configured electronically and physically to receive content from the controller and display the content in a portrait or landscape orientation, as configured or as directed by the controller. A controller 103 may be constructed to be small and/or thin enough to be co-located with the display screen 101 and within the perimeter of the surround 102, particularly when other components are also included to form a more complete assembly, as discussed below. A controller or control platform may also be integrally formed and/or incorporated with, or may be independent of, the electronic display screen 101, surround 102, and/or other components.

As shown in FIG. 1, the controller 103 may be coupled to a storage medium 104, which could be any form of medium suitable for storing digital data, including RAM (random access memory), ROM (read-only memory), flash or other non-volatile solid-state electronic storage, EEPROM (electronically erasable and programmable read only memory), or magnetic and/or optical disk storage. The storage medium 104 may store, for example, control software for execution by the controller 103 and video content of choice for display, under the control of the control software, on the electronic display screen 101. A user interface (not shown), such as a personal computer with a display monitor and keyboard, may be coupled to the controller to enable configuration of the controller with specific user input, such as specific control programs to produce specific displays and/or audio output. An audio device 111, such as a loudspeaker, may further be coupled to the controller 103 via a sound card 110. The audio device 111 may output audio content of choice, stored in the storage medium 104, under the control of the controller 103.

Components of a display system 100 may be powered by a power supply 114 as described further below. A floor display system 100 may further comprise a sensing device 113 to provide for a variety of interactive applications on the floor display system, as described in more detail below. The sensing device 113 could be coupled to the controller 103 and provide signals thereto. The connection of the sensing device to the controller could be wired or wireless.

Data may be stored in the storage medium 104 using, for example, a data port 106 coupled to a common system bus. The bus could be, by way of example only, a USB (Universal Serial Bus). The display system may further comprise a wireless port 107 implemented, for example, using a wireless WAN/LAN card. Through the wireless port 107, the display system 100 may be coupled to and communicate with a network 125. The network could be any kind of network, including a wide area network (WAN) such as the Internet, or a local area network (LAN) including, for example, other display systems. Through the network 125, the display system 100 may be coupled, for example, via a wireless communication device 112, to a server computer 108 of the network. The server computer 108 may be coupled to a database 109. The database 109 may store information relevant to operation of the display system 100. For example, the database may contain video and audio content or control software that is downloadable to the storage medium 104 of the display system. Thus, the display system 100 may be remotely controllable. Similarly, a display system 100 may be coupled to a POS (point of sale) system of one or more establishments, such as a commercial chain of grocery stores. The display system may be coupled, by wired connection or wireless connection, to the POS system through a network 125 or directly, such as through a data port 106 or a wireless port 107. A POS system may be used, for example, to gather and provide information about consumer preferences and inventory and sales data. Information about the effectiveness of specific advertising content in generating sales could be gathered, for example, by correlating sales of a given item in an establishment with the timing of given content displayed on a floor display system. This could be accomplished, for example, by electronically cross-referencing sales transactions, at the time they occur, with the scheduling of particular advertising for display on a floor display system. The floor display system 100 could transmit this advertising scheduling and/or actual display information to the POS system. Alternatively, a server computer of a LAN, for instance, could control the scheduling of content on the various floor display systems of an establishment, and provide the scheduling information to a server of the POS system so that it could be correlated in “real time,” i.e., contemporaneously, with sales transactions. Alternatively, the scheduling information could be correlated with sales records “offline” at a later time. However, the display system 100 need not be networked, and could be controlled locally by, for example, downloading content and control software locally via data port 106. Also, while wireless communication methods and systems are illustrated in FIG. 1, wired systems could also be used, or could be combined with wireless systems.

Various digital video formats may be used to generate images on the display 101, including MPEG (Moving Picture Experts Group), DVD (digital versatile disc or digital video disc), Flash, ASF, WMV, AVI, MOV, DivX, and other known and further developed compressed and uncompressed digital video formats. Further, conventional analog video content, used, for example, in broadcast network television, could be converted into digital video content for display on a display system according to embodiments of the present invention. One such converting process involves taking conventional NTSC (National Television Systems Committee) video from a tape, and capturing it on a computer through a video capture card. An example of this type of card is a Targa 2000 RTX board. Once captured, the video may be compressed into a file with a format that can be played by digital equipment. The file could be saved in MPEG 1 or MPEG 2 format, for example.

According to embodiments, components of the display system as described above could be housed completely internally to the surround, completely externally to the surround, or some components could be internal to the surround, while others are external.

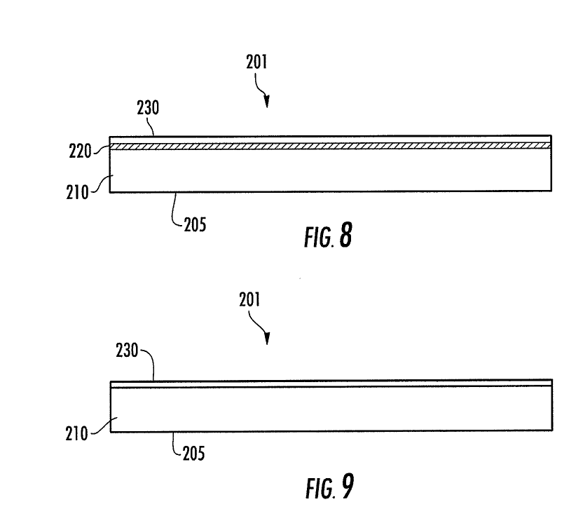

Embodiments of the invention may comprise a sturdy protective cover for the electronic display screen. The display system may have, for example, a sturdy protective cover that is transparent or semi-transparent to allow the electronic display screen to be viewed there through, and that protects the electronic display screen from damage, such as scratches, cracks, chips, tears, or damage caused by environmental dirt. Further implementation details, according to possible embodiments, for such a protective cover are discussed below with reference to FIGS. 8 and 9.

As shown in FIG. 8, a protective cover 201 may comprise a strong transparent member 210, constructed from, by way of example only, glass or a rigid plastic. The protective cover may include a hard coating 220 over the transparent member 210, where the coating 220 is, for example, a diamond-like coating, such as known hard dense carbon coatings that have mechanical properties similar to diamond, but are not as expensive. The coating 220 could also be formed from or include plastic or polymeric coatings, such as those used to coat plastic lenses that are well known in the art. The protective cover may further include an anti-reflective coating 230 over the hard coating 220. The anti-reflective coating 230 may include, for example, multiple layer or organic metal oxides or organic or polymeric coatings with various index of refraction that reduce reflection as known in the lens coating art. Though not shown, in embodiments there could be an anti-reflective coating on a bottom surface 205 of the transparent member 210. Coatings as described in the preceding may reduce glare and resist scratching.

FIG. 9 shows an alternative embodiment where hard coating 220 is omitted and only an anti-reflective coating 230 is provided on a top surface of the transparent member 210. Again, though not shown, in embodiments there could also be an anti-reflective coating on a bottom surface 205 of the transparent member 210.

### Construction and Assembly

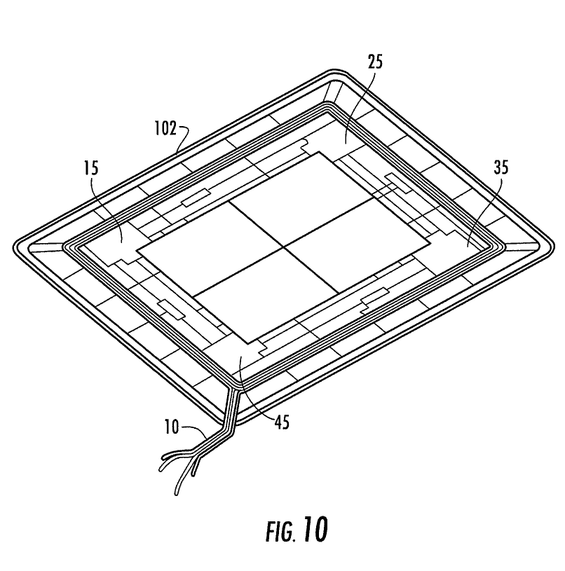

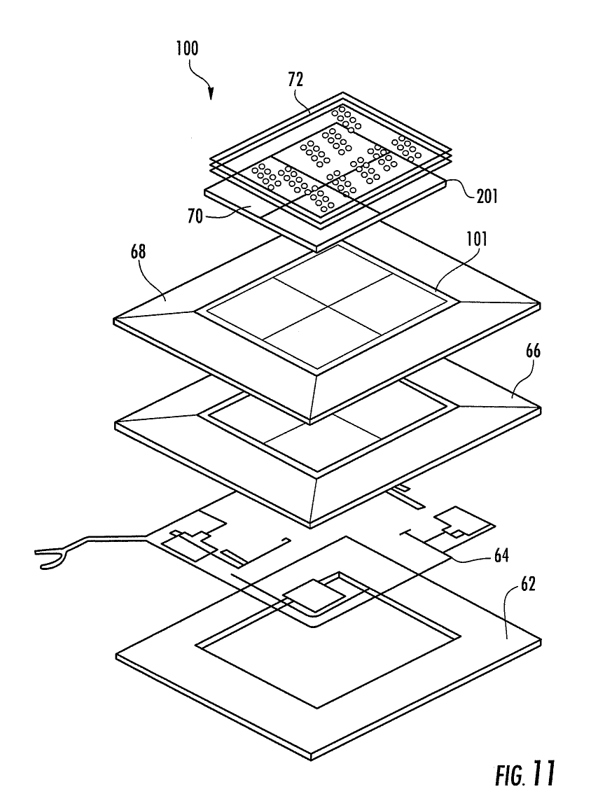

FIG. 10 illustrates details of possible implementations of embodiments of the present invention. As shown in FIG. 10, a display system 100 may comprise four electronic inverters 15, 25, 35, 45 for providing power for driving a back light on each of, for example, four LCD displays in a four-display arrangement for an electronic display system. And power may be supplied, for example, via cables 10 or otherwise as described above with respect to power supply 114.

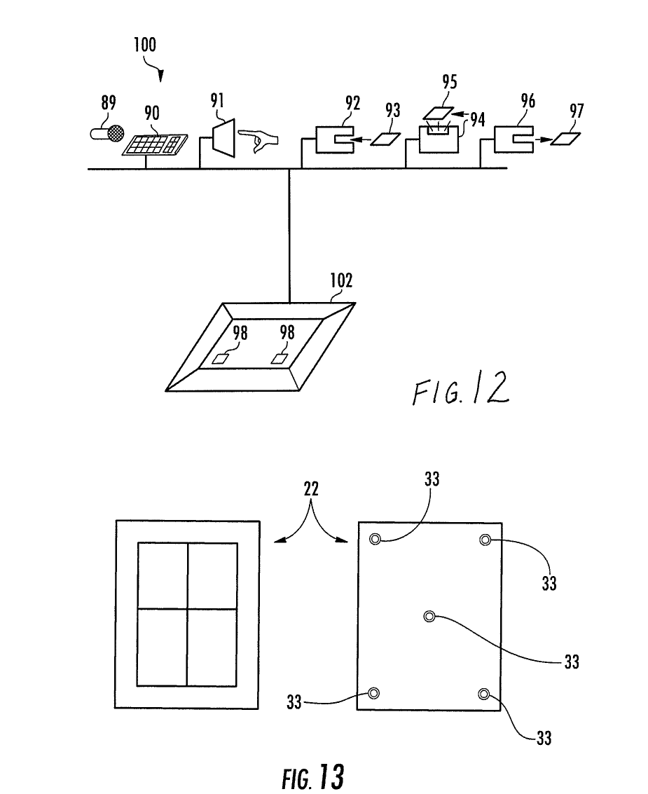

FIG. 11 is an exploded view of a display system 100 according to one embodiment of the present invention. A base component 62 may be configured to receive and support a wiring assembly 64 comprising the four inverters 15, 25, 35, 45 and cables 10 as described above. A structure 66 may be arranged over the wiring assembly 64; structure 66 may be formed from plastic or other material, protect the wiring assembly 64, and provide support for a surround, such as the inclined surfaces 212, 213, 214, 215 described above. The structure 66 may further be configured to receive, for example in recesses formed therein, an electronic display screen 101, such as four separate electronic displays.

Sections of surfacing material 68, such as wood, metal, plastic, carpet, rubber or the like, may be placed over structure 66, to form a surround, such as inclined surfaces 212, 213, 214, 215. A plate of tempered glass including support ribs 70 may be used as a protective cover 201 for the electronic display screen 101. Components of the display system may be held together, for example, with adhesive, epoxy or mechanical fasteners. A plurality of separable protective sheets 72 may be placed over the tempered glass 201.

While not shown, an audio device 111 could be included in the above-described assembly. The audio device could be formed, for example, from thin profile speakers or piezoelectric speakers.

Heat generated by electronics of the display system could be managed and dissipated using potting compounds known for such purposes. The electronics could, for example, be potted and bonded to a thin metal plate that would act as a heat sink to dissipate heat, and various other heat transfer and dissipation methods and devices may be employed.

Embodiments of the present invention may further comprise waterproofing elements, to prevent moisture from, for example, foot traffic or spills from damaging electronic components. Such waterproofing elements could include, for example, potting compounds used as sealants in interstices which could admit damaging moisture. For example, a potting compound could be used in spaces between the electronic display screen and the surround to block out moisture. A water-resistant substance such as silicone could also be used for such a purpose. Further, for example, a water-resistant seal could be formed between a protective cover of the electronic display screen and other surfaces of the display system. A sealant such as silicone could be used to form the water-resistant seal.

### Power

As shown in FIG. 1, the electronic display screen 101 and other components of a display system 100 may receive power and video signals from an integrated or separate controller 103. As described above, components of a display system 100 may be powered by a power supply 114. Power may be supplied to the display system 100 by way of plugging into a power outlet in a wall or floor, such as through a cord, such as to power and use a 450 watt (or lesser or greater value) power supply unit connected to the display system 100. Alternatively, power may be supplied through the use of batteries or fuel cells which may be non-rechargeable or rechargeable. Another possible method of delivering power to the display system include using photoelectric cells that convert ambient light into electricity that can be stored in a battery or used to power the display system directly. The photoelectric cells could be contained, for example, in the surround, or remotely connected to the display through a power cord. Yet further methods of providing power include electromagnetic induction and power over Ethernet (PoE)

The display system 100 may include specialized inverters 4,5, such as one or more miniaturized inverters 5 that are configured (shaped and sized) to be co-located with the electronic display device and fit into the thin height of a display system 100 or inverters 4 that are remote from the electronic display device and coupled or integral with the power supply 114. Of course, inverters that are not specialized may be also implemented, such as conventional inverters. The connection 52 between the controller 103 and the electronic display screen 101 may be wired and include cables, which may attach via DVI hookups or any other commercially available or other known connectors. The power and video signals may travel through the same cable connection. Alternatively, the power and video signals may be separate connections, such as where both the controller 103 and the electronic display screen 101 include wireless hardware components for transmitting video and other control signals.

### Interactivity

Embodiments of a display system according to the present invention may include interactive features, as discussed below.

### Requesting Information

Embodiments of the present invention may include the capabilities of asking consumers for information and recording the requested information. An illustrative example is shown in FIG. 12. As shown in FIG. 12, a number of interactivity devices providing for interaction with persons may be coupled, via wired or wireless connections (e.g., Bluetooth), to a display system 100. The interactivity devices may include, for example, a speech input device 89, such as a microphone, a keyboard or keypad 90 for entering alphanumeric data, a touch-sensitive display screen 91, a card reader 92, a bar code scanner 94, and a coupon dispenser 96. Each of the devices may be arranged at a comfortable level for speaking or typing into, or otherwise handling. The display system 100 could include speech recognition software for performing speech recognition processing of utterances directed by a person into the speech input device 89. The display system might further include pressure sensors 98 under a top surface of a display screen of the display system. The pressure sensors 98 could be implemented as, for example, thin-film contact switches. Each of the foregoing interactivity devices could be coupled to a controller 103 of the display system for sending signals to the controller. The controller could be programmed to perform a desired function depending on the signals received.

As discussed above, such as with reference to FIG. 1, embodiments of a display system 100 according to the present invention provide for interactivity with persons in the vicinity of the display system. In particular, sensing device 113 may take on a number of varying forms, each of which enables the detection of phenomena or activities indicating the presence of persons in the vicinity of the display system, and causes the display system to perform some corresponding action in response. In one such embodiment, the sensing device 113 is a sound-sensing device. The sound-sensing device 113 may be located within the surround 102, or may be located at some distance from the surround. The sound-sensing device could be configured to detect an individual as he or she approached the display system, and to cause a corresponding response to be generated by the display system. For example, the sound-sensing device could be coupled via a wired or wireless connection to the display system, and be configured to send a signal via the connection to the controller 103 to activate the display screen 101 upon the detection of sound waves indicating the approach of a person. Upon receiving the signal, controller 103 could cause the display screen 101 to generate a predetermined display of any desired content: for example, the displayed content could announce a sale, or advertise a product. The content could relate to products on nearby shelves.

The sound-sensing device could be adjustable to detect only predetermined frequencies of sound, and send an activation signal to the display system in response thereto. More particularly, the sound-sensing device could be either an omni-directional or a directional microphone depending upon how noisy the general environment is. An omni-directional microphone has a constant sensitivity regardless of the direction from which sound is coming, and thus would be effective in a quiet environment to detect someone approaching from any direction. The omni-directional microphone could be implemented as one or more small electret microphones placed within or embedded in the surround. While electret microphones are one example, dynamic and condenser microphones could also be used. Commercially available omni-directional microphones include, by way of example only, Audio Technica MT830R, DPA Type 4060, and MMC4041.

In noisy environments, or if there is a particular direction from which the approach of a person is to be detected, a directional microphone may be preferable. A directional microphone is a microphone with a well-defined directional response, and is therefore better able than an omni-directional microphone to filter through sounds coming from a particular direction, while blocking out random environmental noise. Examples of commercially available directional microphones that could be utilized include cardioid microphones, super cardioid microphones, and shotgun microphones. Examples of cardioid microphones include the DPA® Type 4021, the Earthworks® A30X, and the Shure® SM57. Examples of super-cardioid microphones include the Peavey® PVM 480 and the Electrovoice® ND767A. Examples of shotgun microphones include the Beyerdynamic® MCE86 S.1, the Sennheizer® K6 ME-66, and the Shure® SM89. Depending upon how noisy the environment in which the microphone was used, a microphone with greater directional sensitivity might yield better results than a microphone with lesser directional sensitivity. For example, in a very noisy environment, a microphone with high directional sensitivity, such as a super-cardioid or shotgun could be preferable.

In yet another embodiment providing for interactivity, the sensing device 113 may be a motion-detection device. The motion-detection device 113 could be located within the surround 102, or may be located at some distance from the surround, for example, in or on a ceiling or wall near the surround. The motion-detection device could be configured to detect an individual as he or she approached the display system, and to cause a corresponding response to be generated. For example, the motion-detection device could be coupled via a wired or wireless connection to the display system 100 and be configured to send a signal via the connection to activate the display screen 101 upon the detection of motion indicating the approach of a person. The display screen 101 could generate some desired display upon activation; the display system 100 could also generate corresponding audio output. The motion detection device could be adjustable, so that it only detects motion that is within a certain area or perimeter around the display. The motion-detection device could also be directionally sensitive, so that, for example, only customers entering an establishment would trigger the motion-detection device and corresponding display. Motion-detection devices that could be used in association with the display include active and passive motion detection technologies, such as, by way of example only, motion detection devices that utilize IR technology, simple radar, a light beam, and pyroelectric sensors.

The display system of the present invention could use any of the above system and methods, or combinations thereof, or systems and methods not disclosed herein, to implement a motion-detection device 113.

A display system 100 according to embodiments of the present invention may also be made interactive by detecting the presence or movement of a person based on other events within the physical environment. For example, the display system could be coupled via a wired or wireless connection to a door in an entry way or other door of a commercial establishment or other building. Through the connection, the display system could detect the opening of the door, and activate the display in response.

In still further embodiments providing for interactivity, a display system in a commercial establishment could display information customized to a particular individual. Such embodiments could comprise mechanisms for automatically determining a person's identity. For example, as shown in FIG. 1, a display system 100 according to embodiments of the invention could further comprise a contact-less input device 41 capable of receiving identification information from an identity device 42 carried by the person. The contact-less input device 41 may be, for example, a wireless port comprising a receiver and an antenna configured to receive and process wireless electromagnetic signals containing identity information emitted by the identity device 42. The identity information obtained from the identity device 42 could be supplied by the wireless port 41 to the controller 103, which could then access a database, such as database 109, to obtain information relevant to the person based on the identity information.

The display system 100 and associated interactivity devices may be arranged, for example, in a convenient location in a commercial establishment. The display system 100 could generate requests for information, either visually or audibly, to customers passing by. The display system could generate the requests when the proximity of persons was sensed by sensing device 113. In the requests for information, the display system could, for example, request consumer opinion regarding pricing, product specifications, product preferences, coupons, or any other kind of desired information. The display system could prompt a customer to reply, for example, by speaking into the speech input device 89, by keying in information on the keyboard/keypad 90, by pressing certain fields in a display of the touch-sensitive screen 91, by stepping on specified portions of the display system to register responses via pressure on the pressure sensors 98, or by any combination of these.

The display system 100 could record customer responses in a storage medium such as storage medium 104. When enough responses had been collected, the information could be downloaded and analyzed, for example, by brand marketers to determine customer preferences.

The display system 100 could also be configured to respond, either by visual or audio output, to a request from a person, where the request is made either by speaking or by entering data using any of the interactivity devices described above (e.g., keyboard/keypad 90, touch-sensitive screen 91).

The card reader 92 could be used, for example, to obtain identity information from customers. Such identity information may include, but is not limited to: name, age, history of purchases, frequency of store visits, most commonly purchased items, store credit amount, information pertaining to a store discount, and the like. The identity information could be, for example, magnetically encoded on a card 93 readable by the card reader 92. The card 93 could be, for example, a “smart” card. Smart cards (or electronic cards) are known devices that typically contain an embedded computer chip and are typically the size of a conventional credit or debit card. The chip typically contains a microprocessor and memory, which may hold an operating system and application data that may be protected by state-of-the-art security features. Several types of smart card technologies are available in today's marketplace. One example is a memory card. A memory card contains a memory chip and is similar to a small floppy disk or PCMCIA (Personal Computer Memory Card International Association) PC Card device. This type of (memory) chip can store identity information as well as other kinds of information, such as a store credit amount. Based on the relevant information, the display system could be caused to display information specifically relating to or directed to the person. By way of example only, the display could include a personal greeting. Additionally, the controller of the display system could cross-reference the purchase history of the person with the sales or promotional items that are currently available in the commercial establishment. Based on the person's purchase history, the display system could display information notifying the person that a certain item potentially of interest to the person is on sale, and display the aisle location of the item. In addition, the display system could generate a coupon for the item, thus further encouraging the person to purchase the item.

In other embodiments, cards known as microprocessor cards could be used to provide individual identification for purposes of customized displays. Microprocessor cards contain a microprocessor chip that can add, delete, change, and update information. A microprocessor card may further comprise an input/output port, operating system and hard disk, and is thus viewed by many as essentially a miniature computer.

Identification cards such as the smart cards, memory cards and microprocessor cards described above need not be read by a contact-less mechanism. Instead, for example, they could be read or scanned by physical application of the card by a person to a reading device located in a convenient place in the commercial establishment. The reading device may be coupled to, or a component of, an identification system. The identification system could, for example, be implemented in a computer 108 and database 109, coupled to the display system of the present invention. The identity information obtained by the identification system could then be communicated to the display system.

Some types of cards that specifically require physical application by a person to a reading device could also be used with the display system of the present invention. Such cards are known as “contact” cards. Contact cards may have a gold chip embedded in the card. This kind of card requires insertion into a smart card reader and a direct connection with the physical contact points on the card to transmit data. Contact cards are used frequently in banking, communications, health care and loyalty (such as storing automotive service histories) applications.

Cards known as hybrid/twin cards could also be used to provide identification of a person to a display system. These cards have two chips embedded in them: a contact-less chip and a contact chip. The two chips are typically not connected to each other. Instead, typically one chip serves the consumer needs and the other the card issuer needs. In yet other embodiments, combination cards could be used. These cards are also known as dual-interface cards, and they contain one chip that is designed to support both contact and contact-less readers.

Using technology along the lines described above, further embodiments of the present invention could be configured to track movements of persons in a commercial establishment or other public place. In such embodiments, persons could carry identification cards readable by a contact-less mechanism as described above. A plurality of display systems equipped with contact-less detection mechanisms could be arranged in predetermined locations in the establishment, and track the movements of persons by detecting the identification cards. The cards could be personalized (i.e., identify an individual) as described above, or could be generic, and, for example, attached to a shopping cart or basket. Information detailing the movements detected by the floor display systems could be recorded in a database, and used by merchants to, for example, help optimize the layout of a store, help identify where to place impulse-buy items, help determine the content presented on and how to control the content presented on display system of the present invention, and the like. Examples of technologies that may be utilized to track persons carrying or otherwise transporting contact-less identification devices include Bluetooth technology, IRDA, RF link, and other local area network technique to link the display systems.

As is well known, some commercial establishments (e.g., Wal-Mart, Target, large grocery superstores, large department stores, outlet centers, malls, etc.) and do-it-yourself stores (e.g., Home Depot and Lowe's) are very large and contain a vast amount of merchandise. As a result, some individuals shopping in these stores and other commercial establishments have difficulty finding the item(s) for which they are looking. Accordingly, display systems according to embodiments of the present invention may further provide for assisting a person in finding his or her way around a large commercial establishment and finding desired items.

According to such embodiments, upon entering the store, a shopper would either orally (for example, by using a microphone or other sound recording device) or manually (for example, using a keyboard, keypad, or touch monitor type device) enter a desired product or list of products into a machine. The machine would then produce a “trip ticket” detectable by a plurality of display systems arranged in predetermined locations throughout the store. Such desired products or lists of products could also be provided before the shopper arrived at the store, such as through a store website, or from past shopping history. This may be useful for stores that are repeatedly visited by the same customers, such as do-it-yourself stores and grocery stores, which often already provide customers with some type of loyalty identification card or device. Further, this may be particularly useful for stores that are repeatedly visited by the same customers and in which the customers repeatedly purchase the same or similar products, such as grocery stores.

The trip ticket may be a device such as a “smart card” described above, capable of storing information such as the product list entered by the shopper. The information on the trip ticket may be readable via a contact-less technology as discussed in connection with various embodiments described above. Display systems distributed throughout the store may be equipped with contact-less technology for reading the trip tickets. As the shopper moves through the store and approaches the various display systems, the systems may detect and read the trip ticket. Upon detecting a trip ticket and reading a product list thereon, a display system may be configured to display the direction the shopper should walk to locate the desired product(s). Alternatively, the trip ticket might not actually store the product list itself. Instead, the product list or other information corresponding to an identifiable trip ticket could be stored in a database accessible by the display system, and retrieved upon detecting and identifying the trip ticket.

In still further embodiments of the present invention, detection of mobile phones may be provided. Social frictions have been occasioned by the increased use and rising popularity of mobile phones. In many situations, it is considered inappropriate and impolite to have a mobile phone ring and disturb nearby persons. Accordingly, embodiments of the present invention may include a mobile-phone-detection device, using a configuration as shown in FIG. 1, where the contact-less input device 41 is a mobile-phone-detection device. Devices that could be used to detect mobile phones include, for example, near-field RF detectors that can pick up a wide range of RF signals. Such devices are known, for example, for detecting illegal listening devices or “bugs”. One commercially available example includes the MicroAlert™ system that is capable of detecting the presence of a mobile phone or any device emitting RF radiation. The mobile-phone-detection device 41 could be configured to send a signal to the controller 103 of the display system upon the detection of a mobile phone that was powered on. In response to the signal, the controller could cause a display to be generated comprising, for example, a message indicating that the powered-on mobile phone had been detected, and/or sound an alarm indicating that the mobile phone had been detected. Additionally, the display system could display a request that the mobile phone be powered off, or sound an audible request that the mobile phone be powered off. This may be particularly useful in establishments that are sensitive to the use of mobile phones, such as courtrooms, jails, churches, schools, museums, restaurants, libraries, elevators, movie theaters, funeral homes, public modes of transportation (trains, buses, plains, etc.), and other establishments and public spaces that prohibit or discourage the use of mobile phones. Eight display system of the present invention may be a polite but effective way both to identify those individuals to whom it a request or instruction may be desired and to convey the request or instruction in a manner suitable to the environment where the individual and display system are located.

### Contact-Less Scanners

A bar code scanner 94, as shown in FIG. 12, could be used, for example, for a retail checkout. Items with a bar code could be moved across the bar code scanner 94 in order to scan the items. In response, a display system could generate a visual and/or audio message regarding the items and/or images depicting the items. For example, the bar code scanner may be positioned on an elevated surface, such as a grocery store checkout counter or at a self-service checkout counter of any establishment (grocery store, do-it-yourself store, library, etc.), and a customer may scan each item during checkout. The display system may retrieve at least the name and price of each item from a database stored in its own memory or communicate through a wired or wireless connection to a separate device containing the information to use for controlling the display system.

The bar code scanner 94 could also be used, for example, to enable a customer to scan a coupon 95. In response, the display system could generate a visual and/or audio message concerning the coupon. The message might, for instance, inform the customer that the coupon is still valid, or that it is worth double, or the like. The customer might also be enabled to scan a product at the bar code scanner 94, and receive a coupon in response. A coupon 97 could be printed or otherwise generated, and dispensed by the coupon dispenser 96. The coupon dispenser 96 could include a counter to count how many coupons are dispensed and for what products. This information could be recorded by and used by marketers, for example, to gauge consumer reaction to advertisements, prices, and so on.

A similar functionality could be provided if a contact-less identification reader not relying upon line-of-sight, such as a near-field RF receiver rather than and by comparison an optical bar code scanner 94, were used as a contact-less input device 41 in a display system and in conjunction with products that carry contact-less identification devices, such as RF ID tags. For example, a customer may roll a cart filled with groceries over a floor display system causing the display system to display the name and price of each grocery item. Or a customer could walk across the floor display system with items for purchase in the customer's hands or in any type of carrying device, such as a basket. Or a customer could place a basket, bag, or other carrying device containing items for purchase onto an elevated horizontal display system including a contact-less scanner. This may be particularly useful if the customer were to use a carrying device such as a re-usable shopping bag, thereby permitting the customer to essentially bag his or her groceries as he or she shops without having to empty a basket upon checkout to individually scan each item and then bag the groceries. Such batch processing for product purchase or checkout may be useful to improve customer service and decrease checkout times. Further, where a floor display system of the present invention is used, such functionality may easily be implemented without any particular change of infrastructure or operation by merely requiring the customer to roll their shopping cart over the floor display system.

### III. Placement of Displays

A display system may occupy an area of a floor (floor display system) or an elevated surface, such as an elevated horizontal surface (elevated horizontal display) or a vertical surface (vertical display). An elevated horizontal display system may be separable from, removable from, or integral with an elevated horizontal surface. Separable may be, for example, a display system that simply sits on top of an elevated horizontal surface without being attached to the elevated horizontal surface in any way. Removable may be, for example, a display system that is attached to an elevated horizontal surface but can be unattached without causing damage to the elevated horizontal surface for example or leaving a noticeable void. A display system may be attached to an elevated surface by a bolt, hook and loop fasteners, and/or suction cups or like fastener. Integral with may be, for example, a display system that is integrated with an elevated horizontal surface so that separating the display system from the elevated horizontal surface may require causing damage to the elevated horizontal surface or leaving a noticeable void. A display system may be integrated with an elevated horizontal surface by being positioned within a recess of the elevated horizontal surface. A display system may be integrated with an elevated horizontal surface, for example, by forming the two as one unit, gluing or otherwise permanently affixing the display system to the elevated horizontal surface.

As previously shown in FIG. 7, a display system may be located on or in a countertop. A countertop display system 100 may be secured to a countertop 202 in various ways, such as by using bolts, Velcro®, hooks, snaps, or the like. For example, as shown in FIG. 13, a countertop display system 22 (top plan view at left and bottom plan view at right) may have one or more threaded keyholes 33 in its base to facilitate securing the display to a countertop using bolts. Alternatively, as shown in FIG. 7, a countertop display system 22 may be supported in a recess 23 so that the countertop display system 22 simply rests on or in or may be secured within the supporting structure 202. In addition, a countertop display system may be positioned and configured within a countertop or otherwise integral with the countertop so that removing or separating the countertop display system from the countertop surface may require causing damage to the countertop or leaving a noticeable void. It may be preferable to have the top display portion of a countertop display system 102 flush with the surface of the countertop, sunk below the surface of the countertop, or extend outwardly in a horizontal direction or protrude vertically from a recess of the countertop. For example, a countertop surface that is typically used in a manner requiring a level surface, such as for drafting, building, or construction, may benefit from having the top display portion of the countertop display system flush with the surface of the countertop. A countertop display system that is sunk below the surface of the countertop may be used, for example, in environments where the countertop display system may be covered at certain times when the display system is not in use or not desired to be visible and also to provide a uniform countertop surface during such periods of time. A countertop display system that extends or protrudes from a recess of the countertop may be beneficial, for example, to catch the attention of passersby such as in areas of traffic within commercial establishments such as at points of interest like a checkout counter. In some implementations and installations, it may be preferable to have the countertop display system that extends or protrudes from the recess of the countertop to have a tapered, smooth transition from the top display portion to the surface of the countertop. This may provide a more comfortable and even aesthetically pleasing customized display system.

### IV. Communication

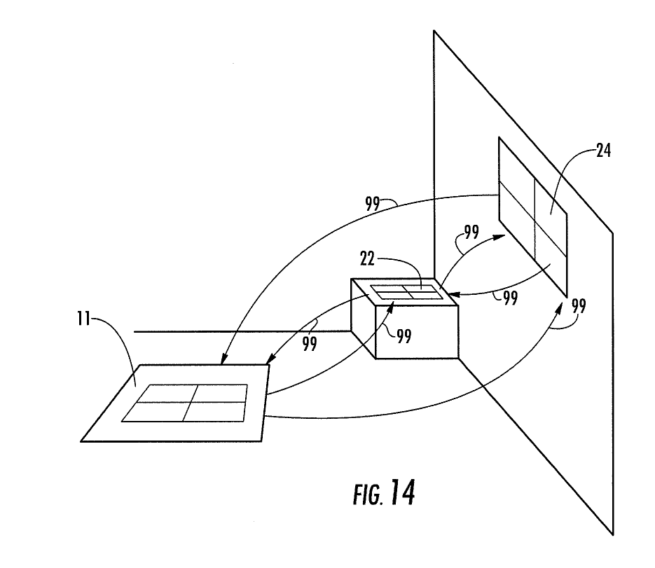

As shown in FIG. 14, various display systems may be configured to communicate and cooperate or otherwise be controlled to work in conjunction, such as sending and/or receiving information 99 between each other. Similar communications are also described below with respect to FIG. 19. A countertop display system 22 may send and/or receive information from other countertop display systems and/or one or more floor display systems 11. Likewise, a floor display system 11 may send and/or receive information with one or more countertop display systems 22. Further, a countertop display system 22 and/or a floor display system 11 may communicate with one or more vertically oriented display systems 24. The information transferred from one display system to another may be advertising information, customer information, navigation information, display content, tracking information, or the like. For example, a floor display system 11 or an elevated display system such as a countertop display system 22 may receive customer data or other information from a smart card or other similar device, as described below. The customer data may include customer preferences and/or historical buying data, a destination, an area of interest, such as the “the drill bit section” of a hardware store, or similar information. A display system may display navigation information based upon the information obtained by the display systems or transferred from another display system. For example, the navigation information may include an image of an arrow pointing in a certain direction, a textual message including a command, such as “turn right,” or other signals for navigation. The display system may also deliver auditory verbal messages from a speaker. For example, the navigation information may include a verbal message stating “turn right, aisle 3, on the left” or other types of directions. A large commercial store, airport, or other location where a customer may need assistance with directions may benefit from such navigation help via a display system such as a floor display system 11, an elevated horizontal display system such as a countertop display system 22, or a vertically oriented display system 24 operating individually or in conjunction with one or more additional display systems. Of course, display systems may provide information other than navigation information. For example, a display system may display advertising information particular to an individual based upon received customer data. For instance, an individual's customer data may indicate an interest in golf. Upon receiving that customer data, a display system may present advertisements related to golf, sports, or the like. The customer data may be used to provide a customized shopping experience. For instance, an individual's customer data may include items the customer intends to purchase. Accordingly, display systems may provide information related to these items, such as their location or advertisements for the items. Similarly, display systems may present advertising for certain goods and services in response to receiving customer data. By using customer data of individuals to direct the information delivered by display systems, the customer enjoys personalized information that is not typically feasible for a commercial establishment or the like to provide. The customers may have more efficient trips to a store or other establishment with less time spent looking or waiting for help or losing time and frustration following the wrong path to a destination or searching for a product. Further, by using multiple display systems, but positioned in different spaces, whether co-located or remotely located, the information or advertising message may be more likely to be recognized by the customer, and the information or advertising message may be specifically designed to correspond to the position of the display system, for example, such as a common advertising message that is presented in three different manners, one for each of three different positions of display systems used to present the advertising message. For example, Nike products might be advertised on one or more floor display systems 11, one or more countertop display systems 22, and one or more vertically oriented display systems 24. Advertisements for Nike shoes and swim products may be presented on the one or more floor display systems 11. Advertisements for Nike watches and athletic apparel may be presented on the one or more countertop display systems 22. And advertisements for Nike hats and eyewear may be presented on the one or more vertically oriented display systems 24. Accordingly, multiple display systems may communicate and cooperate or otherwise be controlled to work in conjunction, including specifically taking advantage of the different positions and modes of presentation of information and advertising available due to the different positions and types of display systems available for use.

A control platform including a controller 103 and any other devices used for operating a display system 100 may be configured to wirelessly communicate with its electronic display screen 101. A control platform may also be configured to communicate with at least one network 125 by a wired or wireless connection. Furthermore, a control platform may be configured to communicate with a different display system through its control platform by a wired or wireless connection. In other words, display systems 100 and component parts thereof, particularly controllers 103 and interfaces 106, 107, 41, may be configured to communicate with one another or with other devices by way of wired or wireless communications. A wireless connection from one display system 100 to another display system 100 could be used to transmit content and control information. Such implementations may be beneficial for temporary or ad hoc situations where a network infrastructure is not available or not economical or practical to implement to support the display systems. Wireless connections between devices could be implemented in many different technologies.

Wireless communication links can be ultrasonic, optical light wave (IR, visible, ultraviolet), lasercomm, radio frequency (RF), terahertz, microwave, electromagnetic, inductively coupled, electrostatic or any other form of propagating electromagnetic energy between a transmitter and a receiver. The mode of data transfer can include time division, frequency division, or code division, and can also be multiple access or spread spectrum. One mode of wireless transmission that is well-suited for contemplated applications of display systems 100 is the Ultra-Wide Band (UWB) mode of transmission. Contemplated commercial applications of display systems 100 include use in electronically noisy environments such as, by way of example only, grocery stores, department stores, appliance stores, industrial facilities, restaurants, hotels, airports, apartments, and residential housing. Ultra-Wide Band (UWB) transmissions work well in these types of environments, among other reasons because when other electronically noisy sources such as machinery, remote door openers, bar-code readers, other RF, TV, low-band transmissions are present, UWB allows high-speed data communications with low power spectral density over a wide spectral range, typically 3-10 gigahertz. UWB also eliminates small-scale fading for arbitrary antenna position or orientation, which may be very useful for a display system positioned on a floor. UWB also is more effective against the deleterious effects of multi-path induced fading that is typical of more narrow-band wireless techniques.

Wireless communications may also include other techniques, either known today or in the future, which may be useful in communicating with and controlling display systems 100. For example, the wireless communications could be compatible with existing and future WiFi standards. Also, wireless communication may be performed using token ring, Bluetooth, cellular, or various other types of technologies and networking architecture, including LANs and WANs.

### Data Distribution and Management

It is contemplated that display systems 100 according to embodiments of the present invention may be deployed in many types of public buildings, including commercial establishments (e.g., markets, stores). In an individual building, there could be a plurality of display systems deployed. The plurality of display systems could be used, for example, to announce sales and prices, provide product descriptions, direct customers to specific locations within an establishment, and the like. Thus, it could be advantageous to control display systems, individually or in groups, at a single location or across multiple locations to generate particular content output, such as video, graphics, text, audio, etc., based on the specific or relative locations of the display systems, and possibly also the locations of individuals in relation thereto. More specifically, the content output by a given display system could, for example, relate to nearby products, such as products on adjacent shelving, or direct an individual to goods that interest the individual as revealed by a smart card or the like. And a display system may relate to the presence of other display systems located nearby and operating together as a cooperation of display systems. Accordingly, embodiments of present invention relate to configuring display systems to generate particular video/audio output, as described below.

### Direct-Link Download

Referring to FIG. 15, a user may locally configure a display system 100 by physically connecting a configuring device 80 such as a hand-held controller/storage device such as a USB flash drive, media player, PDS, portable computer, smart cell phone, or the like, to the display system 100. The connection may be, for example via a direct link 81, such as an impact interface or a cable link to, for example a data port 106 of the display system 100. Alternatively, the connection may be a wireless connection with a wireless port 107 or a contact-less input device 41 of the display system 100. The user may then download selected content and/or control instructions or software from the device 80 to the display system 100, such as into a storage medium 104 of the display system 100. What data is downloaded to a display system may depend, for example, on where the display system is located, and thus what content might be relevant. The content downloaded may be changed by downloading new content by the same method.

### Local Area Network (LAN) Download

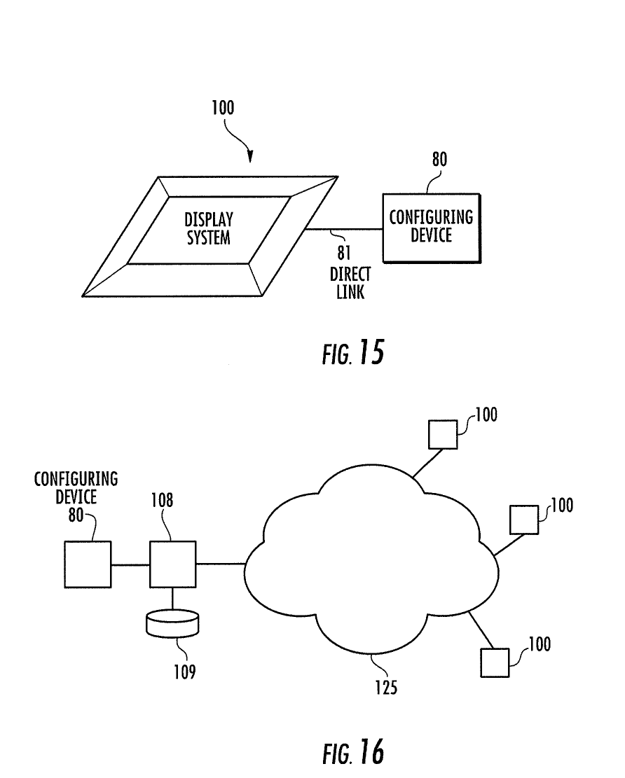

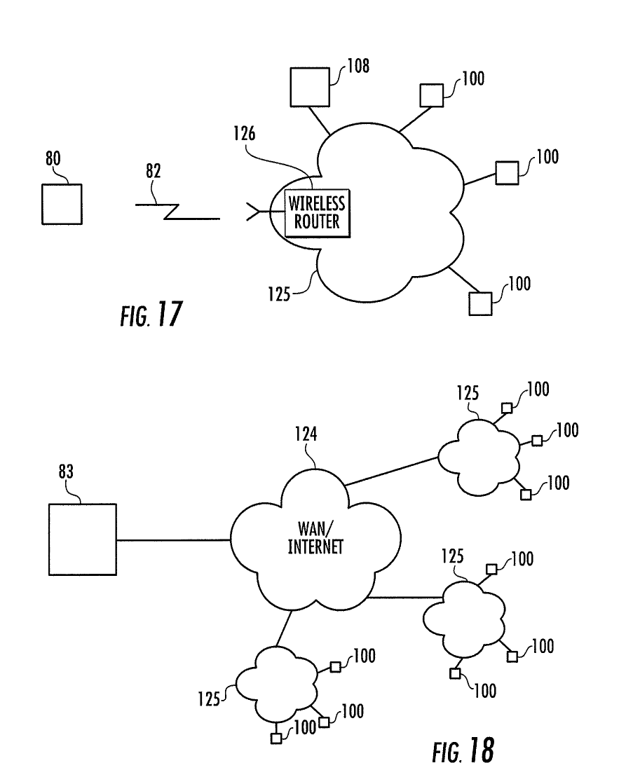

Referring to FIG. 16, a user or automated process may remotely configure a display system 100. For example, an automated process may operate on a network server 108 or a configuring device 80, such as a personal computer connected to the network server 108 and co-located with or remote from the network server 108. Similarly, a user may connect a configuring device 80 to a network server 108. The connection between a configuring device 80 and the computer 108 could be implemented, for example, wirelessly via IRDA (Infrared Data Association), or via a wired USB link. The network sever 108 may in turn be connected, by wired or wireless connections (e.g., using a LAN 125 and Ethernet or WiFi), to one or more display systems 100 any of which may be co-located within the network service 108 or remove from the network server 108. Video/audio content and/or control instructions or software may then be downloaded from the configuring device 80 to the network server 108, and from the network server 108 to connected display systems 100 or simply from the network service 108 to connected display systems. Data downloaded to a first display system may be different from data that is downloaded to a second display system, depending, for example, on the respective locations of the first and second display systems. Alternatively or in addition, the network server 108 could be linked to a database 109 containing content and control software, and a user or automated process could direct the server 108 to download content and/or control software from the database 109 to display systems 100.

### Local Area Wireless Download

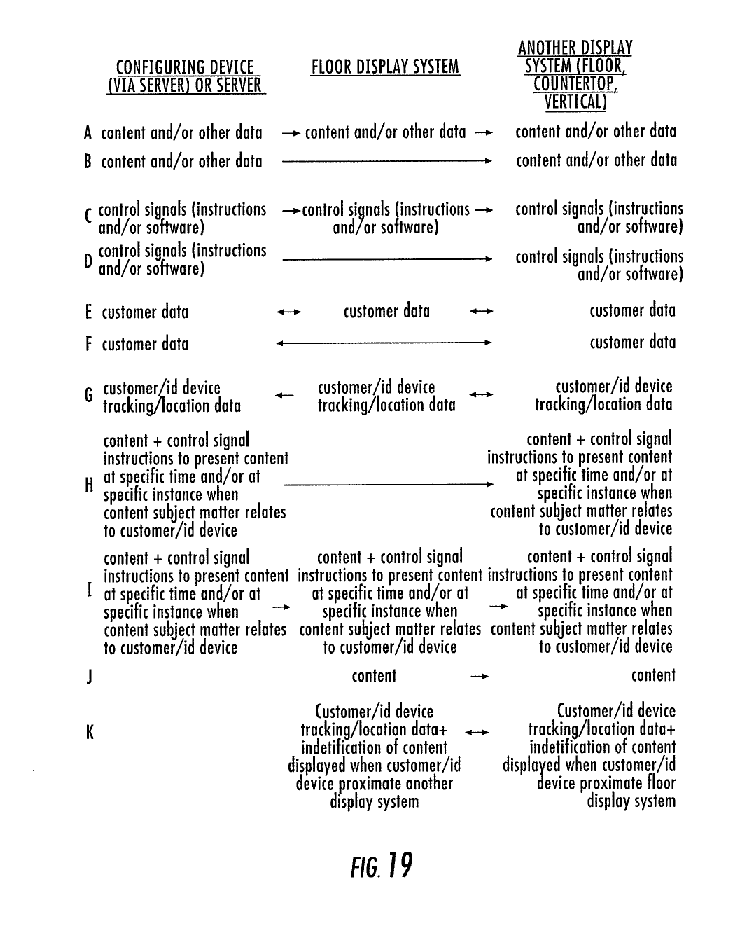

Referring to FIG. 17, according to embodiments of the invention, a user need not connect to a display system 100 as described above with respect to FIG. 15 or to a network server 108 as described above with respect to FIG. 16. Instead, the user may need only be in the vicinity of one or more display systems to be configured and/or a network server 108, and remotely configure the display systems 100 or communicate with the network server 108, such as wirelessly from as much as 100 feet away or more. As shown in FIG. 17, the user could, for example, have a device 80 such as a laptop computer equipped with a short-range wireless transmitter that can send a wireless signal 82 to communicate with each display system 100 in a commercial establishment via, for example, CDMA (code division multiple access) or other similar communication protocol. A wireless router 126 may be used in such an arrangement to provide wireless LAN for the devices, and through which each device transmits signals to communicate with the other devices. Certain devices of the LAN may be connected to the wireless router 126 by a wired connection while others may be wireless connections. In this way, content and/or control instructions or software can be downloaded to display systems 100 without requiring a direct connection with a display system or going through a network server 108. Alternatively, the same short-range wireless transmission could be used to send data to a network server 108, which could then re-distribute the data to display systems 100.

### Wide Area Network (WAN) Download

Referring to FIG. 18, according to embodiments of the invention, remote communication with and configuring of a plurality of display systems in multiple different buildings, such as commercial establishments, and/on multiple other networks is possible. This may be accomplished, for example, with a WAN (wide area network) configuration. More specifically, as shown in FIG. 18, a central control location 83 (or configuring device 80) may be linked via a wired or wireless connection to the Internet or some other wired or wireless (e.g., satellite) WAN 124 to a LAN 125 associated with one or more display systems, such as where each LAN 125 corresponds to a building or other establishment. Each LAN 125 may in turn be linked by wire or wireless connection to one or more display systems 100 such as arranged in the establishment. Video/audio content and/or control instructions or software may then be downloaded from the central control location 83 to a LAN 125, which may then transmit the video/audio content and/or control instructions or software to display systems 100. Since, as discussed above, it may be desirable to have respective display systems 100 in the same establishment generate different video/audio output, each display system 100 could have a unique identifier code assigned to it. This identifier code could be provided in a header of the digital data corresponding to the video/audio content and/or control instructions or software intended for a particular display system 100. The header information could be used to ensure that each display system 100 received the data intended for it. An identifier code may be unique on a LAN or other network arrangement, or may be globally unique such as an IPv6 address or like identification number. An identification code for a display system may be static or dynamic, and LANs or other networks may rely upon network address translation (NAT) if they are only locally unique.

### Satellite Network Download

As a variation of the WAN download technique described above, satellite network download could be used where the wide area network is provided via a satellite or a satellite constellation. Here, a satellite may broadcast data point-to-multi-point to receivers (e.g., dish receivers) of configuring devices 80, network servers 108, or in establishments containing display systems. The data may then be disseminated, e.g., via LAN to respective display systems, or by any other method described above. Satellite systems such as Motorola's Iridium, Hughes' Direct TV, and Boeing Digital Cinema have already demonstrated such capabilities.

### Multiple Display System Direct-Link Communication

According to embodiments of the present invention, data may be transmitted directly from one display system to another display system. This may be accomplished, for example, through the use of wired or wireless communication. In particular, two or more display systems may be directly linked via a wired or wireless connection between the display systems, as well as possibly also being connected to various networks, as discussed above. Accordingly, one display system may attain data by downloading from a network, receiving from another display system, manual input, or the like, and send this, related, or resulting data to a different display system.

FIG. 19 shows a flowchart of example communications between a server, floor display system, and countertop display system according to an embodiment of the present invention, and as described above. The flowchart FIG. 19 refers to a situation in which a configuring device or server is configured to communicate with a floor display system. The configuring device or server may also be configured to communicate with another display system, which may be a floor display system, and countertop display system, or a vertically oriented display system. The floor display system is configured to communicate with another display system. Such an arrangement may be preferable where a single floor display system operates in conjunction with a configuring device or server and also act as a pass-through or controlling device for another display system. This may be preferable so that only one display system (i.e., the floor display system) is required to include components required to be configured to indicate with a configuring device or server, and the other display systems may support a simpler communication subsystem configured to communicate only with the floor display system.

As shown in FIG. 19 at lines A, C, and E, content and/or other data, control signals, and customer data may be directly transmitted from the server to the floor display system. And as shown in FIG. 19 at lines B, D, and F for and embodiments where the configuring device or server is configured to also communicate with another display system, content and/or other data, control signals such as control instructions and/or control software, and customer data may be directly transmitted from service to be another display system. As described above, content and/or other data, control signals such as control instructions and/or control software, and customer data may be transmitted from a configuring device or server, or obtained from a database connected to a server. Content refers to what is displayed on one or more electronic display screen of a display system for presenting information. Other data may be, for example, additional information which may be used by a display system for presenting content or other information on one or more electronic display screens of the display system. For example, if video content is provided to a display system, a corresponding codec (compression/decompression algorithm used for the specific digital video media file). Other data may also be, for example, information used by the floor display systems to remain synchronized temporally and/or operationally with respect to content, timing of displays, and the like. The other data may also, for example, be for error and/or quality control purposes, such as to ensure proper and complete transmission between the devices. Content and/or other data that is transmitted between the display systems may simply be the same content and/or other data sent from the configuring device or server to the floor display system or may be different content and/or other data.

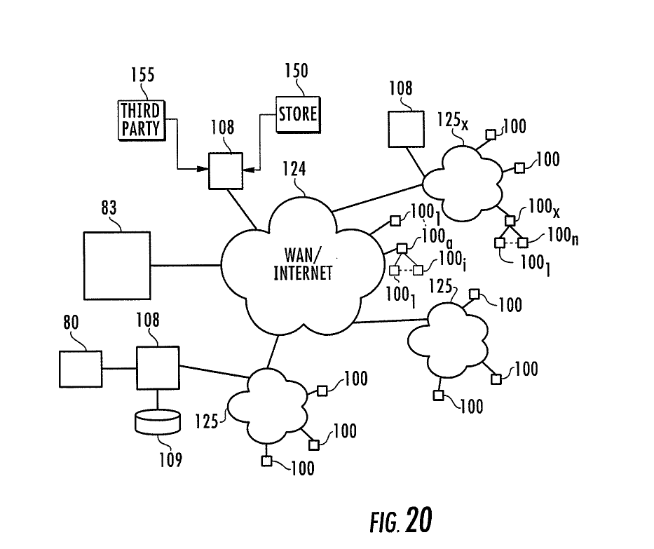

The configuring device or server may also transmit control signals such as control instructions and/or control software to the floor display system, as shown at line C in FIG. 19, and to the another display system, as shown at line D in FIG. 19. Control signals may include operation characteristics for the display systems such as time periods for operation, delay times before entering into a screen saver or sleep/power saving mode, brightness of the display, motion detection operation, or the like. Control signals may also include instructions when and how to display content such as rules for logic-based display routines or operations. Control signals may also include software such as a program, upgrade, update, or algorithm for use by the display system to further operate and/or modify the operation of the display system. As shown at line C, the floor display system may transmit control signals to another display system, such as to pass instructions received from a configuring device or server or difference control signals. Of course, the example communications shown in FIG. 19 and described herein are not exclusive, but single or bi-directional communications may occur between a floor display system, a countertop display system, and other display systems, as shown in FIG. 14 and further in FIG. 20, described below. For example, a substantially vertical or inclined display system may be in communication with a floor display system and/or a countertop display system.

FIG. 19 shows communications of customer data, at line E, between a configuring device or server and a floor display system and another display system and, at line F, between a floor display system and another display system. For example, customer data may be obtained by a server from a database and transmitted to a floor display system for use in presenting customized content to known customers detected proximate the floor display system, such as based upon the customer's prior shopping history, preferences, or desired products to locate for potential purchase. Customer data may also be obtained, for example, by a display system, such as through an interface were associated with the display system. For example, a display system may obtain customer data from a smartcard or other device of a customer, or a customer may directly input data to a display system. And this customer data may be shared between display systems or passed to a configuring device or server for analysis and or storage.

FIG. 19 at line G shows communications of customer/ID device tracking/location data between display systems and between a floor display system and a configuring device or server. As described above, display systems may be configured to detect an identification device, smart card, or the like. Upon detection of such identification information from the ID device, a display system may transmit this information and/or information associated with the detected identification device, such as the duration of the identification device proximate to display system, to the other display systems. Thus, the information transmitted may include more than just basic identification information and may also include detected interests of the individual such as based upon interaction with the display system, customer data such as shopping habits, or other information, as discussed above. Based upon receipt of the identification information, the other display systems may be prepared to display content particular to the individual, among other things, upon detection of the same customer/ID device. Also, such identification information may be useful, such as by a network server, for analysis and/or correlation with stored customer data.

As a further example, lines H and I of FIG. 19, show that content may be coupled with a control signal in a vacation from a configuring device or server to a floor display system or another display system for from a floor display system to another display system. For example, the control signal may provide instructions related to presenting the transmitted content at a specific time and/or at a specific instance when the subject matter of the content relates to a detected ID device. Another example is provided at lines J and K of FIG. 19 that show how display systems (a floor display system and another display system in FIG. 19) may operate in conjunction to form a more encompassing advertising or other content dissemination system for a user. For example, as shown at line J, content may be distributed by one or more of the display systems to other display systems so that this content is available for use by any of the display systems at appropriate times. And, for example, as shown at line K, the display systems may transmit customer/ID device tracking/location data and the identification of specific content to display when a corresponding ID device is proximate a display system. Such functionality may be useful, for example, so that a particular advertisement or consistent content subject matter may appear to follow a customer throughout an establishment by presentation on multiple display systems. For example, a two minute advertisement may be displayed in segments as a customer sequentially passes proximate multiple display systems. Further, the display systems may be configured to provide an overlapping presentation of the segments, such as to ensure that the attention of the customer has been attracted at a subsequent display system before presenting a previously unviewed portion of the advertisement. Similarly, a common theme for the subject matter of content presented to a customer on multiple displays may be achieved using identification information, even apart from knowing any customer data. A display system may obtain a unique identification from a device carried by a customer, even if the device is not intended or known by the customer to be an ID device operational by the establishment, and use that unique identification for recognizing the same customer at other display systems. For example, many individuals carry cell phones and other devices, such as a Bluetooth-enabled phone that is configured to constantly or periodically poll for proximate Bluetooth-compatible devices that may transmit wireless signals that comprise a unique identification number or data representing or that may be used as a unique identification. Such functionality may be described as passive identification by the customer that can be detected and used by a display system of the present invention.

### Displaying Content Based Upon a Variable

As described above, the content displayed by a display system may change depending upon any number of variables available to a display system and upon which the display system is configured to rely upon and/or respond to in presenting content. For example, the time of day, recent sales volumes, or various other variables may be used as describe above or in any like manner. For example, a computer or display system linked to a network or the like may receive data from another computer, display system, or other device. In particular, a computer may receive data from any type of network described above, as well as manually entered data. Processing of the data received may include simply storing the data in a storage medium and determining the display system or systems that the data should be sent to, as well as other types of processing. The data received may include content, such as verbal and graphical images, and/or a schedule for displaying content by display systems at predetermined times. For instance, the schedule may direct the display systems to display breakfast advertisements in the morning and dinner advertisements in the evening. Likewise, the schedule may include instructions for the display systems to display special messages on holidays, such as the Fourth of July. The data received may also include sales volume information or other information directed to the store or company where the display system or systems are located.

The computer or similar device that received the data may transmits at least a portion of the received data to at least one display system or another device using any of the communication means described above. The data transmitted may include instructions for display systems, for example, to display certain types of content. The content may already be saved in the controller of the display system or received at the same time as the instructions. For example, the controller of a display system may include several advertisements relating to breakfast cereal. In such case, the instructions transmitted to the display system may include a selection of the order of advertisements of breakfast cereal, as well as the timing of the display.

At least one display system may receive the data sent from the computer or display system. The display system may then process the data received, which may include determining the appropriate content to display in view of the received information. A controller, whether integrated or separate from an electronic display screen, may modify the displayed content on the electronic display screen based upon the received data and hard-wired information in the controller, stored information in the controller, such as a schedule, or the like.

FIG. 20 shows an example of a store 150 and/or central server for a company of the store and a third party entity 155 each providing a server 108 with data. The store 150 and/or central server for a company of the store may provide inventory and/or sales data. The third party entity 155, such as a commercial advertising provider or a product manufacturer, may provide advertising information, including, for example, advertising content, information about product sales, and information describing products. The server 108 may then provide the data to various display systems 100 via the networks 124, 125. As described above, the server 108 could provide instructions to the display systems on when to display messages or what content to display.

FIG. 20 also shows how transmissions may be broadcast and transmitted to a plurality of display systems 100₁ . . . 100ₐ on a WAN network or the Internet 124. One of the plurality of display systems 100ₐ may also be configured to transmit to a plurality of display systems 100₁ . . . 100ᵢ connected to the display system 100ₐ, but not connected to a network or the Internet. Also shown is how a display system 100ₓ on a LAN 125ₓ may be configured to transmit to a plurality of display systems 100₁ . . . 100ₙ connected to the display system 100ₓ, but not connected to a network or the Internet. Any number of networked and direct connection arrangement may be employed with display systems according to an embodiment of the present invention, and any particular implementation may be specifically configured for the physical environment in which a display system is located, the physical and/or relative location of one or more other display systems, and various other characteristics associated with the implementation, including, for example, the nature of a commercial environment and operational business structure for which one or more display systems are being used to supplement and/or improve upon.

According to one aspect of the present invention, the functions performed by one or more of the entities of a display system, such as a controller 103, server 108, or configuring device 80 may be performed by various means, such as hardware and/or firmware, including those described above, alone and/or under control of a computer program product. The computer program product for performing one or more functions of embodiments of the present invention includes a computer-readable storage medium, such as the non-volatile storage medium, and software including computer-readable program code portions, such as a series of computer instructions, embodied in the computer-readable storage medium. Similarly, embodiments of the present invention may be incorporated into hardware and software systems and subsystems, combinations of hardware systems and subsystems and software systems and subsystems, and incorporated into network devices and systems and display systems thereof. In each of these network devices and systems and display systems, as well as other devices and systems capable of using a system or performing a method of the present invention as described above, the network devices and systems and display systems generally may include a computer system including one or more processors that are capable of operating under software control to provide the techniques described above.

In this regard, each element, communication, or step of a diagram or flowchart, and combinations of elements, communications, and steps in a diagram or flowchart, may be implemented by various means, such as hardware, firmware, and/or software including one or more computer program instructions. As will be appreciated, any such computer program instructions may be loaded onto a computer or other programmable apparatus (i.e., hardware) to produce a machine, such that the instructions which execute on the computer or other programmable apparatus create means for implementing the functions specified in the elements or steps of the diagrams and flowcharts. These computer program instructions may also be stored in a computer-readable memory that can direct a computer or other programmable apparatus to function in a particular manner, such that the instructions stored in the computer-readable memory produce an article of manufacture including instruction means which implement the functions specified in the elements or steps of the diagrams and flowcharts. The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the elements or steps of the diagrams and flowcharts.

Accordingly elements, communications, and steps of a diagram or flowchart support combinations of means for implementing the elements, combinations of means for performing the specified communications, combinations of steps for performing the specified functions, and program instruction means for performing the specified functions. It will also be understood that one or more elements, communications, and steps of a diagram or flowchart, and combinations of elements, communications, and steps of a diagram or flowchart, can be implemented by special purpose hardware-based computer systems which implement the specified elements and perform the specified functions or steps, or combinations of special purpose hardware and computer instructions.

Provided herein are improved display architectures, systems, methods, and computer program products for advertising and other content delivery using one or more floor display systems. A floor display system and an elevated horizontal display system, which may be configured on a countertop, may be used and able to communicate with one another. The display systems may be able to send and receive signals between each other and with a network server or configuring device to operate in cooperation with one another and as instructed. Display systems may be configured to interface with customers to obtain information and configured to detect information about customers proximate the display systems and to use the information to provide improved content delivery to the customer.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system comprising:
a first display system configured to be placed on a floor and comprising an electronic display screen in a plane substantially parallel to the floor, wherein the electronic display screen is configurable to display an electronically modifiable verbal content and an electronically modifiable graphic content; and
a second display system elevated above the floor and comprising an electronic display screen in a plane substantially parallel to the floor, wherein the electronic display screen is configurable to display an electronically modifiable verbal content and an electronically modifiable graphic content.

2. The system of claim 1, wherein the second display system is configured to be supported by and separable from a countertop.

3. The system of claim 2, wherein the second display system is configured to be removably secured to the countertop by at least one of a bolt, hook and loop fasteners, and a suction cup.

4. The system of claim 1, wherein the second display system is integral with a countertop within a recess of the countertop.

5. The system of claim 1, wherein the first electronic display device and second electronic display device are configured to communicate with each other.

6. The system of claim 1, further comprising a third display system, wherein the third display system is in a plane substantially perpendicular to the floor, wherein the third display system is configurable to display an electronically modifiable verbal content and an electronically modifiable graphic content, and wherein at least one of the first and second display systems is configured to communication with the third display system.

7. The system of claim 1, wherein at least one of the display systems comprises a surround.

8. The system of claim 7, wherein the surround is modular and configured to be removably secured to the display system.

9. The system of claim 7, wherein the surround comprises a tapered transition from a top surface of the display system to a surface around the display system.

10. A method, comprising:
providing a first display system on a floor and comprising an electronic display screen in a plane substantially parallel to the floor and configurable to display an electronically modifiable verbal content and an electronically modifiable graphic content;
receiving a first signal at the first display system; and
presenting at least one of an electronically modifiable verbal and an electronically modifiable graphic content on the first display system based at least in part upon the first signal.

11. The method of claim 10, further comprising
detecting an identity device proximate the first display system, wherein detecting an identity device comprises receiving information from the identity device;
receiving a second signal at the first display system indicating the detection of the identity device proximate the first display system and providing the information from the identity device; and
presenting at least one of an electronically modifiable verbal content and an electronically modifiable graphic content on the first display system based at least in part upon the second signal.

12. The method of claim 11, wherein presenting at least one of an electronically modifiable verbal content and an electronically modifiable graphic content on the first display system is based upon both the first and second signals.

13. The method of claim 12, wherein the first signal comprises data related to a first customer including an identification number and at least one of a customer preference associated with the first customer, a desired product of the first customer, and a purchase history of the first customer, wherein the information from the identity device comprises an identification number that matches the identification number, and wherein presenting at least one of an electronically modifiable verbal content and an electronically modifiable graphic content on the first display system is also based upon at least one of the customer preference, the desired product, and the purchase history.

14. The method of claim 12, wherein presenting at least one of an electronically modifiable verbal content and an electronically modifiable graphic content on the first display system is also based upon the current time of day and the location of the first display system.

15. The method of claim 10, further comprising:
providing at second display system comprising an electronic display screen in a plane substantially parallel to the floor and configurable to display an electronically modifiable verbal content and an electronically modifiable graphic content;
sending a second signal from the first display system to the second display system;
receiving the second signal at the second display system; and
presenting at least one of an electronically modifiable verbal content and an electronically modifiable graphic content on the second display system based at least in part upon the second signal.

16. The method of claim 15, further comprising:
sending a third signal from the second display system to the first display system;
receiving the third signal at the first display system; and
presenting at least one of an electronically modifiable verbal content and an electronically modifiable graphic content on the first display system based at least in part upon the third signal.

17. The method of claim 15, further comprising:
detecting an identity device proximate one of the first and second display systems, wherein detecting an identity device comprises receiving information from the identity device;
receiving a third signal at the display system to which the identity device is proximate, the fourth signal indicating the detection of the identity device proximate the display system to which the identity device is proximate and providing the information from the identity device; and
presenting at least one of an electronically modifiable verbal content and an electronically modifiable graphic content on the display system to which the identity device is proximate based at least in part upon the third signal.

18. The method of claim 17, further comprising:
sending a fourth signal from the display system to which the identity device was proximate to the other display system, wherein the fourth signal comprises at least one of the information from the identity device, an indication of the content presented on the display system to which the identity device was proximate when the identity device was detected proximate the display system, an indication of the content presented on the display system to which the identity device was proximate after the identity device was detected proximate the display system, and the location of the display system to which the identity device was proximate;
receiving the fourth signal at the other display system;
detecting the identity device proximate the other display system, wherein detecting the identity device comprises receiving information from the identity device;
receiving a fifth signal at the other display system, the fifth signal indicating the detection of the identity device proximate the other display system and providing the information from the identity device; and
presenting at least one of an electronically modifiable verbal content and an electronically modifiable graphic content on the display system to which the identity device is proximate based at least in part upon the fourth and fifth signals.

19. The method of claim 15, wherein sending the second signal is in response to receiving the first signal.

20. A computer program product comprising a computer-useable medium having control logic stored therein for controlling content presented on a plurality of display systems, the control logic comprising:
a first code for transmitting content to a first display system configured to be placed on a floor and a second display system configured to be elevated above the floor, each display system comprising an electronic display screen in a plane substantially parallel to the floor and configurable to display an electronically modifiable verbal content and an electronically modifiable graphic content, wherein the transmitted content comprises at least one of electronically modifiable verbal content and electronically modifiable graphic content; and
a second code for transmitting instructions to the first display system and the second display system to display the content on the electronic display screen of the respective display system.

21. The computer program product of claim 20, wherein the content transmitted to the first display system is configured for presenting on the floor and the content transmitted to the second display system is configured for presenting above the floor.

22. The computer program product of claim 20, further comprising a third code for transmitting data related to a first customer including an identification number for the customer and at least one of a customer preference associated with the first customer, a desired product of the first customer, and a purchase history of the first customer.

23. The computer program product of claim 22, wherein the instructions to display the content are based upon the data related to the first customer.

24. The computer program product of claim 22, further comprising a forth code for receiving data from at least one of the display systems related to the first customer.

25. The computer program product of claim 20, further comprising a third code for transmitting software code to the first display system and the second display system to be used by the first display system and the second display system to display the content on the electronic display screen of the respective display system.
